(19) United States
(12) Patent Application Publication
(10) Pub. No.: US 2016/0082782 A1
(43) Pub. Date: Mar. 24, 2016

(54) Pneumatic Tire and Method of Manufacturing Same

(71) Applicant: The Yokohama Rubber Co., LTD., Minato-ku, Tokyo (JP)

(72) Inventor: Hideko Seto, Hiratsuka-shi, Kanagawa (JP)

(73) Assignee: The Yokohama Rubber Co., LTD., Minato-ku, Tokyo (JP)

(21) Appl. No.: 14/786,927

(22) PCT Filed: Apr. 17, 2014
(86) PCT No.: PCT/JP2014/060911

§ 371 Date: Oct. 23, 2015

(30) Foreign Application Priority Data
Apr. 25, 2013 (JP) 2013-092469

(51) Int. Cl. B60C 13/04; B60C 13/00

(52) U.S. Cl. CPC B60C 13/04; B60C 13/001

(57) ABSTRACT

A pneumatic tire of the present technology comprises a laminate including at least one film layer disposed on a tire surface and a foundation rubber layer disposed on a bottom side of the at least one film layer, the at least one film layer being constituted from a thermoplastic resin or a thermoplastic elastomer composition in which a thermoplastic resin and an elastomer are blended, the film layer on an outermost side in the laminate exposed on the tire surface being dyed a color different from that of the layer adjacent to the bottom side of the film layer on the outermost side, a plurality of openings being formed by laser processing in the film layer on the outermost side, and the layer adjacent to the bottom side of the film layer on the outermost side being exposed via these openings.

### TECHNICAL FIELD

The present technology relates to a pneumatic tire configured so as to display various information and a method of manufacturing the same, and particularly relates to a pneumatic tire whereby discretionary information can be displayed as necessary, displayed information has excellent visibility, and information display can be averted from falling off, and a method of manufacturing the same.

### BACKGROUND

A manufacturer name, brand, tire size, usage conditions, and the like are displayed on pneumatic tires, but these information displays are transferred by recesses and protrusions carved into a mold, and they have the drawback of being difficult to see because they are the same black color as the tire itself.

On the other hand, seals such as manufacturer markings have been pasted onto tires as manufacturing information (for example, see Japanese Unexamined Patent Application Publication Nos. H10-129219A, H10-129220A and H10-129221A), and in this case, any color can be selected for the information display. However, when a seal is pasted onto a pneumatic tire after vulcanization, there is the problem that the seal may fall off and the required information cannot be securely displayed over an extended period of time.

### SUMMARY

The present technology provides a pneumatic tire whereby discretionary information can be displayed as necessary, displayed information has excellent visibility, and the information display can be averted from falling off.

The pneumatic tire of the present technology comprises a laminate including at least one film layer disposed on a tire surface and a foundation rubber layer disposed on a bottom side of the at least one film layer, the at least one film layer being constituted from a thermoplastic resin or a thermoplastic elastomer composition in which a thermoplastic resin and an elastomer are blended, the film layer on an outermost side in the laminate exposed on the tire surface being dyed a color different from that of the layer adjacent to the bottom side of the film layer on the outermost side, a plurality of openings being formed by laser processing in the film layer on the outermost side, and the layer adjacent to the bottom side of the film layer on the outermost side being exposed via these openings.

Furthermore, the method of manufacturing a pneumatic tire of the present technology is a method of manufacturing a pneumatic tire comprising: preparing a pneumatic tire having a laminate including at least one film layer on a tire surface and a foundation rubber layer disposed on a bottom side of the at least one film layer, the at least one film layer being constituted from a thermoplastic resin or a thermoplastic elastomer composition in which a thermoplastic resin and an elastomer are blended; and the film layer on an outermost side in the laminate exposed on the tire surface being dyed a color different from that of the layer adjacent to the bottom side of the film layer on the outermost side; vulcanizing the pneumatic tire; forming a plurality of openings by laser processing in the film layer on the outermost side; and exposing the layer adjacent to the bottom side of the film layer on the outermost side via the openings.

In the present technology, due to the fact that the pneumatic tire comprises a laminate including at least one film layer and a foundation rubber layer, and the film layer is constituted from a thermoplastic resin or thermoplastic elastomer composition, and a plurality of openings are formed by laser processing in the film layer on an outermost side exposed to a tire surface, and the layer adjacent to the bottom side of the film layer on the outermost side is exposed via these openings, discretionary information can be displayed by means of the shape or arrangement of the openings. Furthermore, visibility of displayed information is excellent because the film layer on the outermost side has been dyed a color different from that of the layer adjacent to the bottom side of the film layer on the outermost side. Moreover, because the laminate can be integrally molded with the tire, falling off of the information display can be averted and the required information can be securely displayed over an extended period of time.

In the present technology, the opening preferably forms information display elements composed of letters, emblems, symbols, or numerals. The openings preferably constitute an information display composed of a company logo, a brand of tire, a barcode, a tire size, manufacturing information, usage conditions, or usage precautions. It is extremely useful that these information display elements or information displays are displayed by means of the openings.

It is preferred that the laminate includes a plurality of film layers, and the film layer on the outermost side exposed on the tire surface is dyed a color different from that of the layer adjacent to the bottom side thereof, and the layer adjacent to the bottom side of the film layer on the outermost side is exposed via the openings. In this case, any color can be selected for the exposed film layer.

The laminate is preferably disposed on the tire inner wall or the outer wall of the side wall portion. In particular, when the laminate is disposed on the tire inner wall, it is preferred that the laminate is disposed on a belt inner region corresponding to a belt layer embedded in the tread portion and the openings are formed in the belt inner region. By so doing, good visibility on the tire inner wall can be assured.

### BRIEF DESCRIPTION OF THE DRAWINGS

FIG. 1 is a meridian cross-sectional view illustrating a pneumatic tire according to an embodiment of the present technology.

FIG. 2 is a cross-sectional view illustrating a laminate composed of a film layer and a foundation rubber layer in the pneumatic tire of FIG. 1.

FIG. 3 is a cross-sectional view illustrating a process of forming an opening in a film layer.

FIG. 4 is a cross-sectional view illustrating a modified example of a laminate composed of a film layer and a foundation rubber layer.

FIG. 5 is a plan view illustrating an example of an information display portrayed via an opening.

FIG. 6 is a plan view illustrating another example of an information display portrayed via an opening.

FIG. 7 is a plan view illustrating another example of an information display portrayed via an opening.

### DETAILED DESCRIPTION

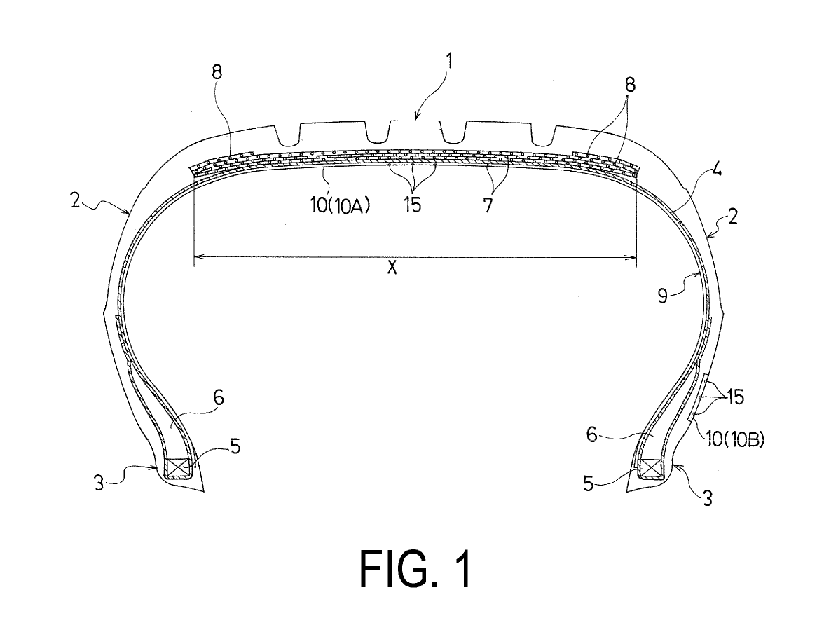

A detailed description of the configuration of the present technology is given below, with reference to the accompanying drawings. FIGS. 1 to 3 illustrate a pneumatic tire according to an embodiment of the present technology. As illustrated in FIG. 1, a pneumatic tire of this embodiment is provided with a tread portion 1 extending in the tire circumferential direction to form an annular shape, a pair of side wall portions 2 that is disposed on both sides of the tread portion 2,2, and a pair of bead portions 3 that is disposed on the inner side in the tire radial direction of the side wall portions 3,3.

A carcass layer 4 is mounted between the pair of bead portions 3,3. The carcass layer 4 includes a plurality of reinforcing cords extending in the tire radial direction, and is folded back around a bead core 5 disposed in each of the bead portions 3 from a tire inner side to a tire outer side. A bead filler 6 having a triangular cross-sectional shape formed from rubber composition is disposed on a periphery of the bead core 5.

On the other hand, a plurality of belt layers 7 are embedded on an outer circumferential side of the carcass layer 4 in the tread portion 1. These belt layers 7 include a plurality of reinforcing cords that incline with respect to the tire circumferential direction and the reinforcing cords are disposed so that the reinforcing cords of each layer intersect each other. In the belt layers 7, an inclination angle of the reinforcing cords with respect to the tire circumferential direction is set in a range from, for example, 10° to 40° . Steel cords are preferably used as the reinforcing cords of the belt layers 7. For the purpose of enhancing high-speed durability, at least one layer of a belt cover layer 8 formed by arranging reinforcing cords at an angle of, for example, not more than 5° with respect to the tire circumferential direction, is disposed on an outer circumferential side of the belt layers 7. Nylon, aramid, or similar organic fiber cords are preferably used as the reinforcing cords of the belt cover layer 8. On the tire inner wall, an inner liner layer 9 is disposed along the carcass layer 4.

Note that the tire reinforcement structure described above is exemplary of a pneumatic tire, but is not limited thereto.

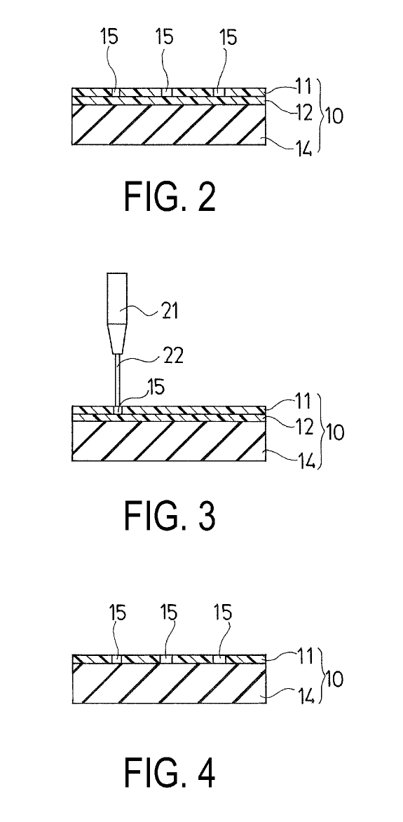

In the pneumatic tire described above, the inner liner layer 9 is constructed from a laminate 10 (10A) including two film layers 11 and 12 disposed on the tire surface and a foundation rubber layer 14 disposed on the bottom side of the film layers 11 and 12, as illustrated in FIG. 2. In the laminate 10A, the foundation rubber layer 14 is a tie rubber layer interposed between the carcass layer 4 and the film layers 11 and 12. In addition to this, on the outer wall of the side wall portion 2, a laminate 10 (10B) is appended, the laminate 10 (10B) including two film layers 11 and 12 disposed on the tire surface and a foundation rubber layer 14 disposed on the bottom side of the film layers 11 and 12. In the laminate 10B, the foundation rubber layer 14 is a tie rubber layer interposed between the rubber layer adjacent to the laminate 10B and the film layers 11 and 12.

Each of the film layers 11 and 12 described above is constituted from a thermoplastic resin or a thermoplastic elastomer composition in which a thermoplastic resin and an elastomer are blended. The thickness of these film layers 11 and 12 is not particularly limited, but is preferably set in the range of, for example, 10 μm to 200 μm. The film layer 11 on the outermost side exposed on the tire surface has been dyed a color different from that of the film layer 12 adjacent to the bottom side thereof. Also, a plurality of openings 15 are formed by laser processing in the film layer 11 on the outermost side, and the film layer 12 adjacent to the bottom side of the film layer 11 on the outermost side is exposed via these openings 15.

When producing such a pneumatic tire, first, the pneumatic tire comprising the laminate 10 including the laminated film layers 11 and 12 and the foundation rubber layer 14 described above is vulcanized. Then, as illustrated in FIG. 3, laser light 22 is irradiated from the processing head 21 of a laser irradiation apparatus onto the film layer 11, and by removing the irradiated portion thereof, a plurality of openings 15 are formed in the film layer 11 on the outermost side, and the film layer 12 is exposed via these openings 15.

The laser light 22 may be irradiated continuously while moving the processing head 21, or it may be irradiated intermittently while moving the processing head 21. The depth of the openings 15 to be formed can be adjusted as appropriate by adjusting the movement speed of the processing head 21 or the intensity of the laser light 22. Examples of the laser that may be used are an infrared laser, a CO₂ (carbon dioxide gas) laser, and a YAG laser, among which a CO₂ (carbon dioxide gas) laser is preferred from the viewpoints of good processability and controllability. The treated width of processing by the laser light (line width) should be set in the range of, for example, 0.2 mm to 1.0 mm.

Due to the fact that a pneumatic tire obtained as described above comprises a laminate 10 including film layers 11 and 12 disposed on the tire surface and a foundation rubber layer 14, and a plurality of openings 15 are formed by laser processing in the film layer 11 which is composed of a thermoplastic resin or thermoplastic elastomer composition, and the film layer 12 is exposed via these openings 15, discretionary information can be displayed by means of the shape or arrangement of the openings 15. Furthermore, because the film layer 11 on the outermost side has been dyed a color different from that of the film layer 12 adjacent to the bottom side thereof, visibility of the displayed information is excellent. Moreover, because the laminate 10 can be integrally molded with the tire, falling off of the information display can be averted and the required information can be securely displayed over an extended period of time, unlike when a seal is pasted on as in the past.

In particular, in the pneumatic tire described above, since the laminate 10 contains a plurality of film layers 11 and 12 and the film layer 12 is exposed via the openings 15, any color can be selected for the color exposed via the openings 15 by dyeing the film layer 12 to a color different from that of the film layer 11 on the outermost side.

As illustrated in FIG. 4, it is also possible to configure the laminate 10 from a single-layer film layer 11 disposed on the tire surface and a foundation rubber layer 14 disposed on the bottom side of the film layer 11. In this case, the film layer 11 on the outermost side exposed on the tire surface is dyed a color different from that of the foundation rubber layer 14 adjacent to the bottom side thereof, and a plurality of openings 15 are formed by laser processing in the film layer 11 on the outermost side, and the foundation rubber layer 14 adjacent to the bottom side of the film layer 11 on the outermost side is exposed via these openings 15.

Even when the laminated structure of FIG. 4 is employed, discretionary information can be displayed by means of the shape and arrangement of the openings 15, visibility of the displayed information is excellent, and falling off of the information display can be averted, similar to the laminated structure of FIG. 2. However, the color that appears when the foundation rubber layer 14 is exposed via the openings 15 is limited to the color of the foundation rubber layer 14 (that is, black).

In the above pneumatic tire, the laminate 10 is disposed on the tire inner wall or the outer wall of the side wall portion 2. When the laminate 10 is disposed on the tire inner wall, the laminate 10 should be disposed at least on in the belt inner region X corresponding to the belt layer 7 embedded in the tread portion 1, and the openings 15 should be formed in the belt inner region X. By so doing, good visibility on the tire inner wall can be assured. Note that although it is preferred that the openings 15 are disposed in the belt inner region X of the tire inner wall, the openings 15 may be formed in the inner wall of the side wall portion 2 or the bead portion 3. The laminate 10 may be formed on the entirety of the tire inner wall, but it may also be selectively formed only in the belt inner region X.

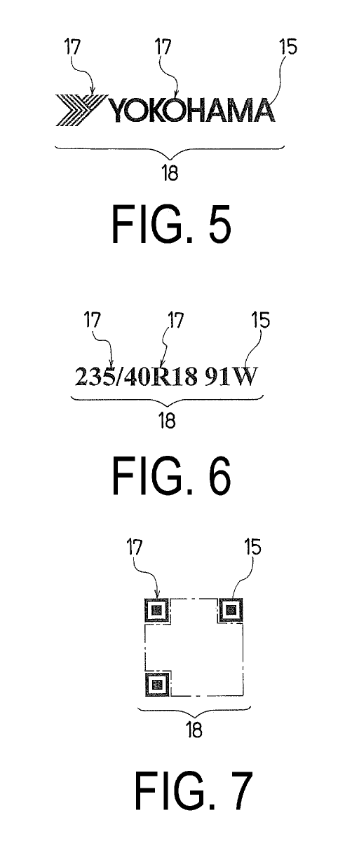

FIGS. 5 to 7 illustrate respective examples of an information display portrayed via an opening. As illustrated in FIGS. 5 to 7, the opening 15 may form an information display element 17 composed of letters, emblems, symbols, or numerals. The openings 15 may constitute an information display 18 composed of a company logo, a brand of tire, a barcode, a tire size, manufacturing information, usage conditions, or usage precautions. When these information displays 18 are displayed by means of the openings 15, excellent visibility of the information displays 18 is assured and falling off of the information displays 18 can be averted.

The thermoplastic resin or thermoplastic elastomer composition in which a thermoplastic resin and an elastomer are blended which is used in the film layers in the present technology will be described below. Examples of the thermoplastic resin preferably used in the present technology include: polyamide resins (for example, nylon 6 (N6), nylon 66 (N66), nylon 46 (N46), nylon 11 (N11), nylon 12 (N12), nylon 610 (N610), nylon 612 (N612), nylon 6/66 copolymers (N6/66), nylon 6/66/610 copolymers (N6/66/610), nylon MXD6 (MXD6), nylon 6T, nylon 6/6T copolymers, nylon 66/PP copolymers, and nylon 66/PPS copolymers); their N-alkoxyalkylated products (for example, methoxymethylated nylon 6, methoxymethylated nylon 6/610 copolymers, and methoxymethylated nylon 612); polyester resins (for example, aromatic polyesters, such as polybutylene terephthalate (PBT), polyethylene terephthalate (PET), polyethylene isophthalate (PEI), PET/PEI copolymers, polyarylate (PAR), polybutylene naphthalate (PBN), liquid crystal polyester, and polyoxyalkylene diimide diacid/polybutylene terephthalate copolymers); polynitrile resins (for example, polyacrylonitrile (PAN), polymethacrylonitrile, acrylonitrile/styrene copolymers (AS), (meth) acrylonitrile/styrene copolymers, and (meth)acrylonitrile/styrene/butadiene copolymers); polymethacrylate resins (for example, polymethyl methacrylate (PMMA), polyethyl methacrylate); polyvinyl resins (for example, polyvinyl acetate, polyvinyl alcohol (PVA), vinyl alcohol/ethylene copolymers (EVOH), polyvinylidene chloride (PVDC), polyvinyl chloride (PVC), vinyl chloride/vinylidene chloride copolymers, vinylidene chloride/methyl acrylate copolymers, vinylidene chloride/acrylonitrile copolymers); cellulose resins (for example, cellulose acetate, and cellulose acetate butyrate); fluororesins (for example, polyvinylidene fluoride (PVDF), polyvinyl fluoride (PVF), polychlorotrifluoroethylene (PCTFE), and ethylene/tetrafluoroethylene (ETFE) copolymers); and imide resins (for example, aromatic polyimide (PI)).

Examples of elastomers used in the present technology include diene rubbers and hydrogenated products thereof (for example, natural rubber (NR), isoprene rubber (IR), epoxidized natural rubber, styrene butadiene rubber (SBR), butadiene rubber (BR, high-cis BR and low-cis BR), nitrile rubber (NBR), hydrogenated NBR, and hydrogenated SBR), olefin rubbers (for example, ethylene propylene rubber (EPDM, EPM), maleic acid modified ethylene propylene rubber (M-EPM), butyl rubber (IIR), isobutylene and aromatic vinyl or diene monomer copolymer, acrylic rubber (ACM), and ionomer), halogen-containing rubbers (for example, Br-IIR, Cl-IIR, brominated copolymer of isobutylene/para-methyl styrene (Br-IPMS), chloroprene rubber (CR), chlorohydrin rubber (CHR), chlorosulfonated polyethylene rubber (C SM), chlorinated polyethylene rubber (CM), and maleic acid modified chlorinated polyethylene rubber (M-CM)), silicone rubbers (for example, methyl vinyl silicone rubber, di-methyl silicone rubber, and methyl phenyl vinyl silicone rubber), sulfur-containing rubbers (for example, polysulfide rubber), fluororubbers (for example, vinylidene fluoride rubbers, fluorine-containing vinyl ether rubbers, tetrafluoroethylene-propylene rubbers, fluorine-containing silicone rubbers, and fluorine-containing phosphazene rubbers), thermoplastic elastomers (for example, styrene elastomers, olefin elastomers, ester elastomers, urethane elastomers, polyamide elastomers), and the like.

If a particular thermoplastic resin among those described above is incompatible with such an elastomer, a compatibilizer may be used as a third component appropriately to make the two compatible with each other. By mixing such a compatibilizer into the blend system, the interfacial tension between the thermoplastic resin and the elastomer is reduced. As a result, the rubber particles constituting the dispersion phase is made finer, so that both components can exhibit their characteristics more effectively. In general, such a compatibilizer has a copolymer structure of at least one of the thermoplastic resin and the elastomer, or a copolymer structure having an epoxy group, a carbonyl group, a halogen group, an amino group, an oxazoline group, or a hydroxyl group, which is capable of reacting with the thermoplastic resin or the elastomer. The compatibilizer can be selected depending on the type of the thermoplastic resin and the elastomer to be mixed therewith. What is normally used is styrene/ethylene-butylene-styrene block copolymers (SEBS) and their maleic acid-modified products, EPDM, EPM, EPDM/styrene or EPDM/acrylonitrile graft copolymers and their maleic acid-modified products, styrene/maleic acid copolymers, reactive phenoxine, and the like. The blending proportion of such a compatibilizer is not particularly limited, but may preferably be 0.5 to 10 parts by weight relative to 100 parts by weight of the polymer components (the total amount of the thermoplastic resin and the elastomer).

In the thermoplastic elastomer composition, the component ratio of a particular thermoplastic resin to a particular elastomer is not particularly limited, and may be appropriately set so as to have a structure in which the elastomer is dispersed as a discontinuous phase in a matrix of the thermoplastic resin. However, the preferable range is 90/10 to 15/85 in weight ratio.

In the present technology, the thermoplastic resin and the thermoplastic elastomer composition may be mixed with another polymer, for example, the above-described compatibilizer, in such an amount that the required characteristics are not hindered. The purposes of mixing such a polymer are to improve the compatibility between the thermoplastic resin and the elastomer, to improve the molding workability of the material, to improve the heat resistance, to reduce cost, and the like. Examples of the material used for the polymer include polyethylene (PE), polypropylene (PP), polystyrene (PS), ABS, SBS, and polycarbonate (PC). Furthermore, a reinforcing agent such as a filler (calcium carbonate, titanium oxide, alumina, and the like), carbon black, or white carbon, a softening agent, a plasticizer, a processing aid, a pigment, a dye, or an anti-aging agent that are generally compounded with polymer compounds may be optionally compounded so long as the required characteristics are not hindered.

When mixed with the thermoplastic resin, the elastomer can be dynamically vulcanized. A vulcanizer, a vulcanization aid, vulcanization conditions (temperature, time), and the like, during the dynamic vulcanization can be determined as appropriate in accordance with the composition of the elastomer to be added, and are not particularly limited.

Generally available rubber vulcanizers (crosslinking agents) can be used as the vulcanization agent. Specifically, a sulfur vulcanizing agent is exemplified by powdered sulfur, precipitated sulfur, highly dispersible sulfur, surface treated sulfur, insoluble sulfur, dimorpholine disulfide, alkylphenol disulfide, and the like and, for example, approximately 0.5 to 4 phr (in the present specification, “phr” refers to parts by weight per 100 parts per weight of an elastomer component; same below) can be used.

Moreover, examples of an organic peroxide-based vulcanizer include benzoyl peroxide, t-butyl hydroperoxide, 2,4-dichlorobenzoyl peroxide, 2,5-dimethyl-2,5-di(t-butyl peroxy)hexane, and 2,5-dimethylhexane-2,5-di(peroxyl benzoate). Such an organic peroxide-based vulcanizer can be used in an amount of, for example, around 1 to 20 phr.

Furthermore, examples of a phenol resin-based vulcanizer includes brominated alkylphenol resins and mixed crosslinking system containing an alkyl phenol resin with a halogen donor such as tin chloride and chloroprene. Such a phenol resin-based vulcanizer can be used in an amount of, for example, around 1 to 20 phr.

Examples of other vulcanizers include zinc oxide (approximately 5 phr), magnesium oxide (approximately 4 phr), litharge (approximately 10 to 20 phr), p-quinone dioxime, p-dibenzoylquinone dioxime, tetrachloro-p-benzoquinone, poly-p-dinitrosobenzene (approximately 2 to 10 phr), and methylenedianiline (approximately 0.2 to 10 phr).

As necessary, a vulcanization accelerator may be added. As the vulcanization accelerator, approximately 0.5 to 2 phr, for example, of a generally available vulcanization accelerator of an aldehyde-ammonia base, a guanidine base, a thiazole base, a sulfenamide base, a thiuram base, a dithio acid salt base, a thiourea base, or the like can be used.

Specific examples include an aldehyde ammonia vulcanization accelerator such as hexamethylene tetramine and the like; a guanidine vulcanization accelerator such as diphenyl guanidine and the like; a thiazole vulcanization accelerator such as dibenzothiazyl disulfide (DM), 2-mercaptobenzothiazole and its Zn salt, a cyclohexylamine salt, and the like; a sulfenamide vulcanization accelerator such as cyclohexyl benzothiazyl sulfenamide (CBS), N-oxydiethylene benzothiazyl-2-sulfenamide, N-t-butyl-2-benzothiazole sulfenamide, 2-(thymol polynyl dithio)benzothizole, and the like; a thiuram vulcanization accelerator such as tetramethylthiuram disulfide (TMTD), tetraethylthiuram disulfide, tetramethylthiuram monosulfide (TMTM), dipentamethylenethiuram tetrasulfide, and the like; a dithionate vulcanization accelerator such as Zn-dimethyl dithiocarbamate, Zn-diethyl dithiocarbamate, Zn-n-butyl dithiocarbamate, Zn-ethylphenyl dithiocarbamate, Te-diethyl dithiocarbamate, Cu-dimethyl dithiocarbamate, Fe-dimethyl dithiocarbamate, pipecoline pipecolyl dithiocarbamate, and the like; and a thiourea vulcanization accelerator such as ethylene thiourea, diethyl thiourea.

Additionally, a vulcanization accelerator which is generally-used for a rubber can be used. For example, zinc oxide (approximately 5 phr), stearic acid, oleic acid and their Zn salts (approximately 2 to 4 phr), or the like can be used.

The method for producing the thermoplastic elastomer composition is as follows. The thermoplastic resin and the elastomer (unvulcanized one in the case of rubber) are melt-kneaded in advance by a twin screw kneader extruder or the like. The elastomer is dispersed as a dispersion phase (domain) in the thermoplastic resin forming a continuous phase (matrix). When the elastomer is vulcanized, the vulcanizer can be added during the kneading process to dynamically vulcanize the elastomer. Although the various compounding agents (except for the vulcanizer) may be added to the thermoplastic resin or the elastomer during the kneading process, it is preferable to premix the compounding agents before the kneading process. The kneader used for kneading the thermoplastic resin and the elastomer is not particularly limited. A screw extruder, kneader, Banbury Mixer, twin screw kneader extruder, or the like can be used as the kneader. Among these, a twin screw kneader extruder is preferably used for kneading the thermoplastic resin and the elastomer and for dynamically vulcanizing the elastomer. Furthermore, two or more types of kneaders can be used to successively knead the thermoplastic resin and the elastomer. As a condition for the melt-kneading, it is preferable that a temperature be equal to or higher than a melting temperature of the thermoplastic resin. A shear rate when kneading is preferably from 1000 to 7,500 sec⁻¹. A total kneading time is from 30 seconds to 10 minutes. Additionally, when a vulcanizing agent is added, a vulcanization time after the addition is preferably from 15 seconds to 5 minutes. The polymer composition produced by the above method may be formed into a desired shape by a generally-used method for forming a thermoplastic resin such as injection molding and extrusion molding.

The thermoplastic elastomer composition thus obtained has a structure in which the elastomer is dispersed as a discontinuous phase in the matrix of the thermoplastic resin. By having such a structure, it becomes possible to provide the film layer with sufficient flexibility and sufficient rigidity that is attributed to the effect of the resin layer as a continuous phase. Furthermore, it becomes possible to obtain, during molding, a molding workability equivalent to that of the thermoplastic resin regardless of the amount of the elastomer.

The Young's modulus in a standard atmosphere of the thermoplastic resin and thermoplastic elastomer composition as set forth in JIS K7100 is not particularly limited, but is preferably from 1 to 500 MPa, and more preferably from 50 to 500 MPa.

The thermoplastic resin or the thermoplastic elastomer composition can be formed into a sheet or film to be used as a single unit. Alternatively, an adhesive layer may be laminated thereon in order to improve the adhesiveness to the adjacent rubber. Specific examples of an adhesive polymer that constitutes the adhesive layer include an ultra high molecular weight polyethylene (UHMWPE) having a molecular weight of not less than 1,000,000 and preferably not less than 3,000,000; acrylate copolymers such as ethylene-ethylacrylate copolymers (EEA), ethylene-methylacrylate resins (EMA), and ethylene-acrylic acid copolymers (EAA), and maleic anhydrate adducts thereof; polypropylene (PP) and maleic acid-modified products thereof; ethylene-propylene copolymers and maleic acid-modified products thereof; polybutadiene resins and maleic anhydrate-modified products thereof, styrene-butadiene-styrene copolymers (SBS); styrene-ethylene-butadiene-styrene copolymers (SEBS); thermoplastic fluororesins; thermoplastic polyester resins; and the like. These polymers can be formed into a sheet or film by being extruded with, for example, a resin extruder in accordance with a generally-used method. A thickness of the adhesive layer is not particularly limited, but is preferably small in order to reduce tire weight; and is preferably from 5 μm to 150 μm.

### EXAMPLES

Tires in Working Examples 1 to 4 were produced as follows: a pneumatic tire was vulcanized, the tire having a tire size of 235/40R18 91W, in which a laminate including at least one film layer disposed on the tire surface in a prescribed location and a foundation rubber layer disposed on the bottom side of the film layer is provided, the film layer being constituted from a thermoplastic elastomer composition in which a thermoplastic resin and an elastomer were blended, and the film layer on the outermost side exposed on the tire surface being dyed a color different from that of the layer adjacent to a bottom side thereof. Then, a plurality of openings were formed by laser processing in the film layer on the outermost side, and the layer adjacent to the bottom side of the film layer on the outermost side was exposed via these openings. As a result, the openings constituted an information display including letters and symbols.

In the tire of Working Example 1, the inner liner layer was constituted from the laminate illustrated in FIG. 4. The film layer on the outermost side exposed on the tire surface was white, and the foundation rubber layer adjacent to the bottom side thereof was black. A plurality of openings were formed by laser processing in the film layer on the outermost side, and the foundation rubber layer adjacent to the bottom side of the film layer on the outermost side was exposed via these openings.

In the tire of Working Example 2, the laminate illustrated in FIG. 4 was appended on the outer wall of the side wall portion. The film layer on the outermost side exposed on the tire surface was white, and the foundation rubber layer adjacent to the bottom side thereof was black. A plurality of openings were formed by laser processing in the film layer on the outermost side, and the foundation rubber layer adjacent to the bottom side of the film layer on the outermost side was exposed via these openings.

In the tire of Working Example 3, the inner liner layer was constituted from the laminate illustrated in FIG. 2. The film layer on the outermost side exposed on the tire surface was black, and the film layer adjacent to the bottom side thereof was white. A plurality of openings were formed by laser processing in the film layer on the outermost side, and the film layer adjacent to the bottom side of the film layer on the outermost side was exposed via these openings.

In the tire of Working Example 4, the laminate illustrated in FIG. 2 was appended on the outer wall of the side wall portion. The film layer on the outermost side exposed on the tire surface was black, and the film layer adjacent to the bottom side thereof was white. A plurality of openings were formed by laser processing in the film layer on the outermost side, and the film layer adjacent to the bottom side of the film layer on the outermost side was exposed via these openings.

Basic materials of the blend shown in Table 1 were prepared as the thermoplastic elastomer composition that constitutes the film layers. To this material, 1 wt. % titanium oxide (TiO) or 0.1 wt. % carbon black was added to make it white or black. The thickness of each of the film layers was approximately 80 μm. On the other hand, a rubber composition of the blend shown in Table 2 was used as the tie rubber layer serving as the foundation rubber layer.

TABLE 1

| | | Parts by |
|---|---|---|
| | | mass |
| BIMS^{a)} | “Exxpro 3035” made by | 100 |
| | Exxon Mobil Chemical Co. | |
| Zinc oxide | “Zinc oxide type III” made by | 0.5 |
| | Seido Chemical Industry Co., Ltd. | |
| Stearic acid | Industrial stearic acid | 0.2 |
| Zinc stearate | “Zinc stearate” made by NOF Corporation | 1 |
| N6/66 | “UBE Nylon 5033B” made by | 100 |
| | Ube Industries, Ltd. | |
| Modified | “HPR-AR201” made by Dupont-Mitsui | |
| EEA^{b)} | Polychemicals Co., Ltd. | 10 |

Remarks: ^{a)}Brominated isobutylene-p-methylstyrene copolymer
^{b)}Maleic anhydride-modified ethylene-ethylacrylate copolymer

TABLE 2

| | | Parts by |
|---|---|---|
| | | mass |
| Styrene butadiene | “Nipol 1502” manufactured by Zeon | 50 |
| rubber | Corporation | |
| Natural rubber | SIR-20 | 50 |
| Carbon black | “Seast V” manufactured by Tokai Carbon | 60 |
| | Co., Ltd. | |
| Stearic acid | Industrial stearic acid | 1 |
| Aromatic oil | “Desolex No. 3” manufactured by Showa | 7 |
| | Shell Sekiyu K.K. | |
| Zinc oxide | “Zinc oxide III” made by Seido | 3 |
| | Chemical Industry Co., Ltd. | |
| Modified resorcin | “Sumikanol 620” made by Taoka | 2 |
| formaldehyde | Chemical Co., Ltd. | |
| condensate | | |
| Methylene donor | Modified etherified methylolmelamine | 6 |
| | (“Sumikanol 507AP” manufactured by | |
| | Taoka Chemical Co., Ltd.) | |
| Sulfur | 5% oil-extension treated sulfur | 6 |
| Vulcanization | Di-2-benzothiazolyl disulfide | 2.2 |
| accelerator | “NOCCELER-DM” manufactured by | |
| | Ouchi Shinko Chemical Industrial Co., | |
| | Ltd. | |

When the information displays portrayed via the openings were checked in the tires of Working Examples 1 to 4 described above, the letters and symbols could be clearly recognized and visibility was good in all tires. In the tires of Working Examples 1 to 4, discretionary information as necessary can be displayed after vulcanization of the pneumatic tire, and falling off of the information display can be averted.

1. A pneumatic tire comprising:
a laminate including at least one film layer disposed on a tire surface and a foundation rubber layer disposed on a bottom side of the at least one film layer;
the at least one film layer being constituted from a thermoplastic resin or a thermoplastic elastomer composition in which a thermoplastic resin and an elastomer are blended,
the film layer on an outermost side in the laminate exposed on the tire surface being dyed a color different from that of the layer adjacent to the bottom side of the film layer on the outermost side,
a plurality of openings being formed by laser processing in the film layer on the outermost side, and
the layer adjacent to the bottom side of the film layer on the outermost side being exposed via these openings.

2. The pneumatic tire according to claim 1, wherein the openings form information display elements composed of letters, emblems, symbols, or numerals.

3. The pneumatic tire according to claim 1, wherein the openings constitute an information display composed of a company logo, a brand of tire, a barcode, a tire size, manufacturing information, usage conditions, or usage precautions.

4. The pneumatic tire according to claim 1, wherein the at least one film layer includes a plurality of film layers, and the film layer on an outermost side exposed on the tire surface is dyed a color different from that of the film layer adjacent to a bottom side of the film layer on the outermost side, and the film layer adjacent to the bottom side of the film layer on the outermost side is exposed via the openings.

5. The pneumatic tire according to claim 1, wherein the laminate is disposed on a tire inner wall.

6. The pneumatic tire according to claim 5, wherein the laminate is disposed in a belt inner region corresponding to a belt layer embedded in a tread portion, and the openings are formed in the belt inner region.

7. The pneumatic tire according to claim 1, wherein the laminate is disposed on an outer wall of a side wall portion.

8. A method of manufacturing a pneumatic tire, comprising:
preparing a pneumatic tire having a laminate including at least one film layer on a tire surface and a foundation rubber layer disposed on a bottom side of the at least one film layer, the at least one film layer being constituted from a thermoplastic resin or a thermoplastic elastomer composition in which a thermoplastic resin and an elastomer are blended and the film layer on an outermost side in the laminate exposed on the tire surface being dyed a color different from that of the layer adjacent to the bottom side of the film layer on the outermost side;
vulcanizing the pneumatic tire;
forming a plurality of openings by laser processing in the film layer on the outermost side; and
exposing the layer adjacent to the bottom side of the film layer on the outermost side via the openings.

9. The method of manufacturing a pneumatic tire according to claim 8, further comprising forming the openings as information display elements composed of letters, emblems, symbols, or numerals.

10. The method of manufacturing a pneumatic tire according to claim 8, further comprising forming the openings to constitute an information display composed of a company logo, a brand of tire, a barcode, a tire size, manufacturing information, usage conditions, or usage precautions.

11. The method of manufacturing a pneumatic tire according to claim 8, wherein the at least one film layer includes a plurality of film layers, and the film layer on an outermost side exposed on the tire surface is dyed a color different from that of the film layer adjacent to a bottom side of the film layer on the outermost side, and the film layer adjacent to the bottom side of the film layer on the outermost side is exposed via the openings.

12. The method of manufacturing a pneumatic tire according to claim 8, wherein the laminate is disposed on a tire inner wall.

13. The method of manufacturing a pneumatic tire according to claim 12, wherein the laminate is disposed in a belt inner region corresponding to a belt layer embedded in a tread portion, and the openings are formed in the belt inner region.

14. The method of manufacturing a pneumatic tire according to claim 8, the laminate is disposed on an outer wall of a side wall portion.
